(19) United States
(12) Patent Application Publication
(10) Pub. No.: US 2026/0092138 A1
(43) Pub. Date: Apr. 2, 2026

(54) BLOCKED POLYISOCYANATE COMPOSITION, CURABLE RESIN COMPOSITION COMPRISING THE COMPOSITION, AND CURED PRODUCT

(71) Applicant: KOEI CHEMICAL COMPANY, LIMITED, Chiba (JP)

(72) Inventors: Mitsuki ONODA, Chiba (JP); Kasumi SASAKI, Chiba (JP)

(73) Assignee: KOEI CHEMICAL COMPANY, LIMITED, Chiba (JP)

(21) Appl. No.: 19/337,193

(22) Filed: Sep. 23, 2025

(30) Foreign Application Priority Data
Sep. 30, 2024 (JP) 2024-170635

(51) Int. Cl. C08G 18/80; C08G 18/22; C08G 18/24; C08G 18/28; C08G 18/78

(52) U.S. Cl. CPC C08G 18/808; C08G 18/227; C08G 18/244; C08G 18/2865; C08G 18/7831

(57) ABSTRACT

Provided is a blocked polyisocyanate composition having excellent storage stability, a curable resin composition comprising the blocked polyisocyanate composition, and a cured product. Specifically, provided is a blocked polyisocyanate composition comprising a blocked polyisocyanate compound in which an isocyanate group of a polyisocyanate compound is blocked with a secondary amine compound represented by the following Formula (1), and an amine compound represented by at least one formula selected from the group consisting of Formulas (2-1), (2-2), (2-3), and (2-4):

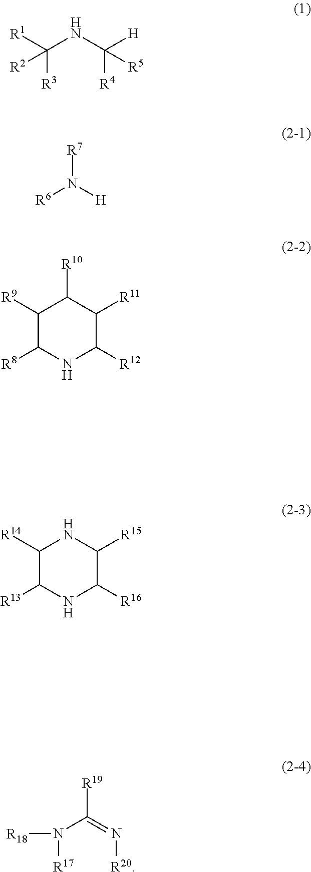

### TECHNICAL FIELD

The present invention relates to a blocked polyisocyanate composition, a curable resin composition comprising the blocked polyisocyanate composition, and a cured product.

### BACKGROUND ART

Blocked polyisocyanate compounds are compounds obtained by reacting a polyisocyanate compound with a blocking agent containing active hydrogen groups that are capable of reacting with isocyanate groups. Blocked polyisocyanate compounds are inactive at ordinary temperatures with the isocyanate group of the polyisocyanate being blocked by a blocking agent; however, heating causes dissociation of the blocking agent to regenerate the isocyanate group. Due to such properties, blocked polyisocyanate compounds have been widely used as one-component coating compositions by mixing with a polyol and a curing catalyst in applications such as paints.

For example, PTL 1 discloses a blocked isocyanate composition comprising a blocked isocyanate compound obtained from a triisocyanate compound represented by Formula (I) in Claim 1 of this international publication and at least two blocking agents, and also discloses a one-component coating composition comprising the blocked isocyanate composition and a polyol.

PTL 1 also discloses that the two blocking agents may include an amine-based compound and a pyrazole-based compound, and that a metal salt, such as dibutyltin dilaurate, and a tertiary amine may be contained as a curing accelerating catalyst.

The invention disclosed in PTL 1 provides a blocked isocyanate composition that exhibits low viscosity, low crystallinity, and low-temperature curability, as well as excellent storage stability when used in paints.

Additionally, for example, PTL 2 discloses a blocked isocyanate composition comprising a blocked isocyanate derived from a triisocyanate compound represented by Formula (I) in Claim 1 of this publication and a blocking agent comprising an amine-based compound, and discloses a coating composition comprising the blocked isocyanate composition and an active hydrogen compound.

PTL 2 also discloses that the amine-based compound may be a secondary amine compound and that a curing acceleration catalyst, such as an amine compound, may be contained.

The invention disclosed in PTL 2 provides a blocked isocyanate composition that exhibits excellent curability while maintaining excellent blocking resistance, and exhibits excellent gloss and image transfer properties when formed into a coating film.

### CITATION LIST

### Patent Literature

PTL 1: WO2018/235896
PTL 2: JP2022-041366A

### SUMMARY OF INVENTION

### Technical Problem

In the conventional techniques stated above, even when a blocked polyisocyanate composition comprising a blocked isocyanate compound, a polyol, and a curing catalyst is stored at an ordinary temperature, curing of the blocked polyisocyanate composition can sometimes occur during storage. Under such circumstances, there is demand for a blocked polyisocyanate composition comprising a blocked isocyanate compound in which curing is prevented from occurring during storage and in which excellent storage stability is achieved.

Therefore, the problems to be solved by the present invention are to improve the storage stability of blocked polyisocyanate compositions and curable resin compositions comprising the blocked polyisocyanate compositions, and to provide a blocked polyisocyanate composition having excellent storage stability, and a curable resin composition comprising the blocked polyisocyanate composition, as well as a cured product obtained by curing the curable resin composition.

### Solution to Problem

As a result of extensive research, the inventors of the present application found that the present invention can solve the above problems. The present invention has thus been accomplished.

Specifically, the present invention provides the following blocked polyisocyanate compositions according to [1] to [3], curable resin compositions according to [4] to [6], and a cured product according to [7].

[1]

A blocked polyisocyanate composition comprising:
a blocked polyisocyanate compound in which an isocyanate group of a polyisocyanate compound is blocked with a secondary amine compound represented by the following Formula (1); and
an amine compound represented by at least one formula selected from the groups consisting of the following Formulas (2-1), (2-2), (2-3), and (2-4):

### Formula (1):

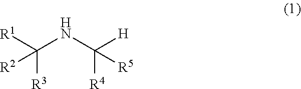

wherein R¹, R², R³, R⁴, and R⁵ are each independent of one another; R¹, R², and R³ each represent a C₁-C₂₀ hydrocarbon group that may be substituted with a heteroatom; R⁴ and R⁵ each represent a C₁-C₂₀ hydrocarbon group that may be substituted with a heteroatom, or a hydrogen atom; and R¹, R², R³, R⁴, and R⁵ may form a ring structure together with at least one of the carbon atoms to which they are bonded;

### Formula (2-1):

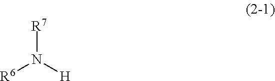

wherein R⁶ and R⁷ are each independent of one another; R⁶ and R⁷ each represent a C₁-C₂₀ hydrocarbon group that may be substituted with a heteroatom; R⁶ and R⁷ may form a ring structure together with the nitrogen atom to which they are bonded;

### Formula (2-2):

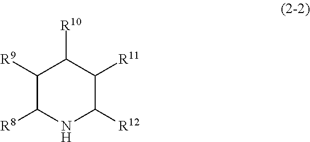

wherein R⁸, R⁹, R¹⁰, R¹¹, and R¹² are each independent of one another; R⁸, R⁹, R¹⁰, R¹¹, and R¹² each represent a hydrogen atom or a hydrocarbon group; and when R⁸, R⁹, R¹⁰, R¹¹, and R¹² each represent a hydrocarbon group, they each represent a C₁-C₂₀ hydrocarbon group that may be substituted with a heteroatom, and they may form a ring structure together with the carbon atoms to which they are bonded;

### Formula (2-3):

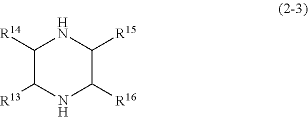

wherein R¹³, R¹⁴, R¹⁵, and R¹⁶ are each independent of one another; R¹³, R¹⁴, R¹⁵, and R¹⁶ each represent a hydrogen atom or a hydrocarbon group; and when R¹³, R¹⁴, R¹⁵, and R¹⁶ each represent a hydrocarbon group, they each represent a C₁-C₂₀ hydrocarbon group that may be substituted with a heteroatom, and they may form a ring structure together with the carbon atoms to which they are bonded; and

### Formula (2-4):

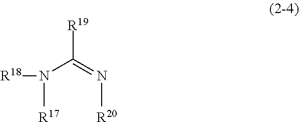

wherein R¹⁷, R¹⁸, R¹⁹, and R²⁰ are each independent of one another; R¹⁷, R¹, R¹⁹, and R²⁰ each represent a hydrogen atom or a hydrocarbon group; and when R¹⁷, R¹⁸, R¹⁹, and R²⁰ each represent a hydrocarbon group, they each represent a C₁-C₂₀ hydrocarbon group that may be substituted with a heteroatom, and they may form a ring structure together with the carbon atom and/or at least one of the nitrogen atoms to which they are bonded.

[2]

The blocked polyisocyanate composition according to [1], wherein the polyisocyanate compound is
at least one polyisocyanate selected from the group consisting of aliphatic polyisocyanates, alicyclic polyisocyanates, aromatic polyisocyanates, and aromatic aliphatic polyisocyanates, or
a modified polyisocyanate formed from at least one member selected from the group consisting of aliphatic polyisocyanates, alicyclic polyisocyanates, aromatic polyisocyanates, and aromatic aliphatic polyisocyanates.

[3]

The blocked polyisocyanate composition according to [1], wherein R¹, R², and R³ in the secondary amine compound represented by Formula (1) each represent a C₁-C₂ hydrocarbon group, and R⁴ and R⁵ each represent a C₁-C₂ hydrocarbon group or a hydrogen atom.

[4]

A curable resin composition comprising the blocked polyisocyanate composition according to any one of [1] to [3], and a compound having an isocyanate-reactive group.

[5]

The curable resin composition according to [4], wherein the compound having an isocyanate-reactive group is a polyol compound or a polyamine compound.

[6]

A curable resin composition comprising the curable resin composition according to [4] and a curing catalyst.

[7]

A cured product obtained by curing the curable resin composition according to [6].

### Advantageous Effects of Invention

The present invention can provide a blocked polyisocyanate composition having excellent storage stability, a curable resin composition comprising the blocked polyisocyanate composition, and a cured product.

### DESCRIPTION OF EMBODIMENTS

### Blocked Polyisocyanate Composition

The blocked polyisocyanate composition of the present invention comprises a blocked polyisocyanate compound in which an isocyanate group of a polyisocyanate compound is blocked with a secondary amine compound represented by Formula (1), and an amine compound represented by at least one formula selected from the group consisting of Formulas (2-1), (2-2), (2-3), and (2-4).

### Blocked Polyisocyanate Compound

The blocked polyisocyanate compound is explained below. Examples of the blocked polyisocyanate compound include compounds obtained by reacting polyisocyanate compounds and blocking agents to block the isocyanate groups in the polyisocyanate compounds with the blocking agents. The blocked polyisocyanate compounds may be used singly or as a mixture of two or more.

### Polyisocyanate Compound

The polyisocyanate compound that constitutes the blocked polyisocyanate compound is not particularly limited, as long as it is a compound having two or more isocyanate groups. Examples of polyisocyanate compounds include the following:
(i) aliphatic polyisocyanates,
(ii) alicyclic polyisocyanates,
(iii) aromatic polyisocyanates,
(iv) aromatic aliphatic polyisocyanates, and
(v) modified polyisocyanates formed from at least one member selected from the group consisting of aliphatic polyisocyanates, alicyclic polyisocyanates, aromatic polyisocyanates, and aromatic aliphatic polyisocyanates.

Examples of (i) aliphatic polyisocyanates include 1,4-tetramethylene diisocyanate, 1,6-hexamethylene diisocyanate, 2,2,4-trimethylhexamethylene diisocyanate, 2,4,4-trimethylhexamethylene diisocyanate, lysine diisocyanate, dimer acid diisocyanate, and the like.

Examples of (ii) alicyclic polyisocyanates include 1,3-bis(isocyanatomethyl)cyclohexane, 1,4-bis(isocyanatomethyl)cyclohexane, 3-isocyanatomethyl-3,3,5-trimethylcyclohexane (isophorone diisocyanate (IPDI)), bis-(4-isocyanatocyclohexyl)methane, norbornane diisocyanate, and the like.

Examples of (iii) aromatic polyisocyanates include 2,4′-diphenylmethane diisocyanate, 4,4′-diphenylmethane diisocyanate, crude diphenylmethane diisocyanate, 1,4-phenylene diisocyanate, 2,4-tolylene diisocyanate, 2,6-tolylene diisocyanate, 3,3′-dimethyl-4,4′-diisocyanatobiphenyl, 3,3′-dimethyl-4,4′-diisocyanatodiphenylmethane, 1,5-naphthylene diisocyanate, and the like.

Examples of (iv) aromatic aliphatic polyisocyanates include 1,3-xylylene diisocyanate, 1,4-xylylene diisocyanate, α,α,α′,α′-tetramethylxylylene diisocyanate, and the like.

Examples of (v) modified polyisocyanates include isocyanate-terminated compounds obtained by the reaction of the above polyisocyanate compounds with compounds having an active hydrogen group, and reaction products of the polyisocyanate compounds and/or the isocyanate-terminated compounds (e.g., adduct-type polyisocyanates, and modified isocyanates obtained by allophanatization reaction, carbodiimidization reaction, uretodionization reaction, isocyanuration reaction, uretoniminization reaction, biuretization reaction, or the like); and preferably adduct-type polyisocyanates, polyisocyanates modified by isocyanuration reaction (polyisocyanates having an isocyanurate bond), polyisocyanates modified by biuretization reaction (polyisocyanates having a biuret bond), and polyisocyanates modified by urethanization reaction (polyisocyanates having a urethane bond).

### Polyisocyanate Having a Biuret Bond

A polyisocyanate having a biuret bond is obtained by reacting a so-called biuretizing agent, such as water, tert-butanol, or urea, with a polyisocyanate at a molar ratio of the biuretizing agent/isocyanate groups in the polyisocyanate of about 1/2 to about 1/100, and removing the unreacted polyisocyanate for purification.

Examples of polyisocyanates having a biuret bond include a biuret modified product of 1,6-hexamethylene diisocyanate (HDI), a biuret modified product of isophorone diisocyanate (IPDI), and a biuret modified product of toluene diisocyanate (TDI), which are represented by Formula (1a) below. Commercial products include Desmodur N75, Desmodur N100, and Desmodur N3200 (all produced by Sumika Covestro Urethane Co., Ltd.); Duranate 24A-100, Duranate 22A-75P, and Duranate 21S-75E (all produced by Asahi Kasei Corporation); and the like.

### Formula (1a):

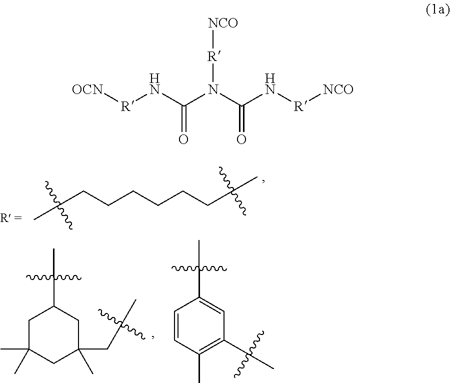

### Polyisocyanate Having an Isocyanurate Bond

A polyisocyanate having an isocyanurate bond is obtained, for example, by performing the cyclic trimerization reaction using a catalyst etc., stopping the reaction when the conversion rate reaches about 5 to about 80 mass %, and removing the unreacted polyisocyanate for purification. In this case, a mono- to hexavalent alcohol compound can be used in combination.

The catalyst for the above isocyanuration reaction is generally preferably a basic catalyst. Examples of the catalyst include the following:
(1) hydroxides of tetraalkylammonium, such as tetramethylanmonium, tetraethylammonium, and trimethylbenzylammonium; and salts of organic weak acids, such as acetic acid and capric acid;
(2) hydroxides of hydroxyalkylammonium, such as trimethylhydroxypropylammonium, trimethylhydroxyethylammonium, triethylhydroxypropylammonium, and triethylhydroxyethylammonium; and salts of organic weak acids, such as acetic acid and capric acid;
(3) metal salts of alkyl carboxylic acids with, for example, tin, zinc, and lead;
(4) alcoholates of metals, such as sodium and potassium; (5) aminosilyl group-containing compounds, such as hexamethyldisilazane;
(6) Mannich bases;
(7) a combination of tertiary amines and epoxy compounds;
(8) phosphorus-based compounds, such as tributylphosphine. These can be used in a combination of two or more.

If the catalyst may adversely affect paints or coating film properties, the catalyst may be neutralized with an acidic compound. Examples of acidic compounds include inorganic acids, such as hydrochloric acid, phosphorous acid, and phosphoric acid; sulfonic acids or derivatives thereof, such as methanesulfonic acid, p-toluenesulfonic acid, p-toluenesulfonic acid methyl ester, and p-toluenesulfonic acid ethyl ester; ethyl phosphate, diethyl phosphate, isopropyl phosphate, diisopropyl phosphate, butyl phosphate, dibutyl phosphate, 2-ethylhexyl phosphate, di(2-ethylhexyl)phosphate, isodecyl phosphate, diisodecyl phosphate, oleyl acid phosphate, tetracosyl acid phosphate, ethyl glycol acid phosphate, butyl pyrophosphate, butyl phosphite, and the like. These may be used in a combination of two or more.

Examples of polyisocyanates having an isocyanurate bond include isocyanurate-modified HDI, isocyanurate-modified IPDI, and isocyanurate-modified TDI, which are represented by the following Formula (1b). Commercial products include Sumidur N3300, Desmodur 3900, Desmodur Z4470BA, Desmodur XP2763, Desmodur IL1351BA, and Desmodur HLBA (all produced by Sumika Covestro Urethane Co., Ltd.); Duranate TPA-100, Duranate MFA-75B, Duranate TUL-100, and Duranate TSA-100 (all produced by Asahi Kasei Corporation); and the like.

### Formula (1b):

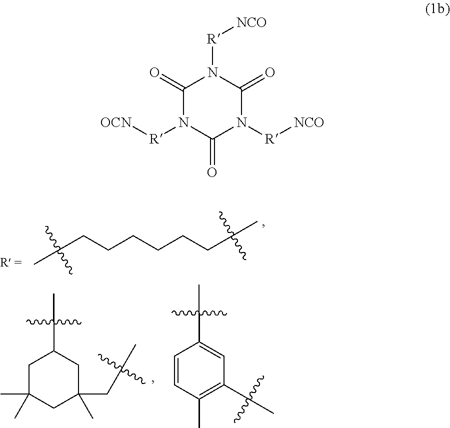

### Polyisocyanate Having a Urethane Bond

A polyisocyanate having a urethane bond is obtained, for example, by reacting a di- to hexavalent alcohol-based compound, such as trimethylolpropane (hereinafter referred to as TMP), with diisocyanate at a molar ratio of hydroxyl groups in the alcohol-based compound/isocyanate groups in the polyisocyanate of about 1/2 to about 1/100, and then removing the unreacted polyisocyanate for purification. Removal of the unreacted polyisocyanate for purification is not necessarily required.

Examples of polyisocyanates having a urethane bond include a reaction product of HDI and TMP, a reaction product of IPDI and TMP, and a reaction product of TDI and TMP. Commercial products include Sumidur N3300, Desmodur 3900, Desmodur Z4470BA, Desmodur XP2763, Desmodur IL1351BA, and Desmodur HLBA (all produced by Sumika Covestro Urethane Co., Ltd.); Duranate TPA-100, Duranate MFA-75B, Duranate TUL-100, and Duranate TSA-100 (all produced by Asahi Kasei Corporation); and the like.

In one embodiment, the polyisocyanate compound may be a polyisocyanate represented by the following Formula (3) or a modified polyisocyanate represented by the following Formula (3).

### Formula (3):

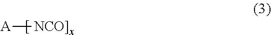

wherein A represents a residue obtained by removing an isocyanate group from at least one polyisocyanate selected from the group consisting of aliphatic polyisocyanates, alicyclic polyisocyanates, aromatic polyisocyanates, and aromatic aliphatic polyisocyanates, or a residue obtained by removing an isocyanate group from a modified isocyanate formed from at least one member selected from the group consisting of aliphatic polyisocyanates, alicyclic polyisocyanates, aromatic polyisocyanates, and aromatic aliphatic polyisocyanates; and x is an integer of 2 or more and 20 or less.

The polyisocyanate represented by Formula (3) is preferably (i) an aliphatic polyisocyanate or (ii) an alicyclic polyisocyanate.

The modified polyisocyanate represented by Formula (3) is preferably (v) a modified polyisocyanate formed from at least one member selected from the group consisting of aliphatic polyisocyanates, alicyclic polyisocyanates, aromatic polyisocyanates, and aromatic aliphatic polyisocyanates.

These polyisocyanates may be used singly or as a mixture of two or more.

### Blocking Agent

In the present invention, the blocking agent that blocks some of the isocyanate groups of the polyisocyanate or modified polyisocyanate mentioned above is a secondary amine compound represented by the following Formula (1).

### Formula (1):

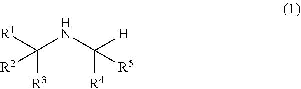

wherein R¹, R², R³, R⁴, and R⁵ are each independent of one another; R¹, R², and R³ each represent a C₁-C₂₀ hydrocarbon group that may be substituted with a heteroatom; R⁴ and R⁵ each represent a C₁-C₂₀ hydrocarbon group that may be substituted with a heteroatom, or a hydrogen atom; and R¹, R², R³, R⁴, and R⁵ may form a ring structure together with at least one of the carbon atoms to which they are bonded.

In Formula (1), R¹, R², R³, R⁴, and R⁵ are each independent of one another.

In Formula (1), R¹, R², and R³ each represent a C₁-C₂₀ hydrocarbon group that may be substituted with a heteroatom, preferably a C₁-C₁₂ hydrocarbon group that may be substituted with a heteroatom, more preferably a C₁-C₆ hydrocarbon group that may be substituted with a heteroatom, further preferably a C₁-C₄ hydrocarbon group that may be substituted with a heteroatom, particularly preferably a C₁-C₂ hydrocarbon group that may be substituted with a heteroatom, and most preferably a C₁-C₂ hydrocarbon group.

In Formula (1), R⁴ and R⁵ each represent a C₁-C₂₀ hydrocarbon group that may be substituted with a heteroatom, or a hydrogen atom.

When R⁴ and R⁵ each represent a C₁-C₂₀ hydrocarbon group that may be substituted with a heteroatom, they are each preferably a C₁-C₁₂ hydrocarbon group that may be substituted with a heteroatom, more preferably a C₁-C₆ hydrocarbon group that may be substituted with a heteroatom, and still more preferably a C₁-C₄ hydrocarbon group that may be substituted with a heteroatom.

R⁴ and R⁵ are each particularly preferably a C₁-C₂ hydrocarbon group that may be substituted with a heteroatom, or a hydrogen atom, and most preferably a C₁-C₂ hydrocarbon group or a hydrogen atom.

Examples of hydrocarbon groups that are not substituted with a heteroatom and that are represented by R¹, R², R³, R⁴, and R⁵ include methyl groups, ethyl groups, propyl groups, n-butyl groups, s-butyl groups, t-butyl groups, pentyl groups, neopentyl groups, hexyl groups, octyl groups, benzyl groups, phenyl groups, and the like, with methyl groups, ethyl groups, neopentyl groups, and phenyl groups being preferred, and methyl groups and ethyl groups being more preferred.

Examples of hydrocarbon groups that are substituted with a heteroatom and that are represented by R¹, R², R³, R⁴, and R⁵ include a hydrocarbon group in which at least one —CH₂— constituting the hydrocarbon group is substituted with, for example, at least one of —O—, —NH—, —N(R)— (wherein R represents a hydrocarbon group), —S—, —SO₂—, or the like.

R¹, R², R³, R⁴, and R⁵ may form a ring structure together with at least one of the carbon atoms to which they are bonded.

Examples of secondary amine compounds represented by Formula (1) include tert-butyl-ethylamine, tert-butyl-n-propylamine, tert-butyl-iso-propylamine, tert-butyl-n-butylamine, tert-butyl-sec-butylamine, tert-butyl-n-octylamine, tert-butyl-2-ethylhexylamine, tert-pentyl-ethylamine, tert-pentyl-n-propylamine, tert-pentyl-iso-propylamine, tert-pentyl-sec-butylamine, 1,1,3,3-tetramethylbutyl-ethylamine, 1,1,3,3-tetramethylbutyl-n-propylamine, 1,1,3,3-tetramethylbutyl-iso-propylamine, 1,1,3,3-tetramethylbutyl-n-butylamine, 1,1,3,3-tetramethylbutyl-sec-butylamine, 1,1,3,3-tetramethylbutyl-n-octylamine, 1,1,3,3-tetramethylbutyl-2-ethylhexylamine, and the like.

### Amine Compound

The amine compound contained in the blocked polyisocyanate composition of the present invention is an amine compound represented by at least one formula selected from the group consisting of Formula (2-1), Formula (2-2), Formula (2-3), and Formula (2-4).

### Amine Compound Represented by Formula (2-1)

### Formula (2-1):

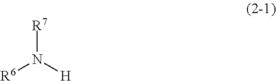

wherein R⁶ and R⁷ are each independent of one another; R⁶ and R⁷ each represent a C₁-C₂₀ hydrocarbon group that may be substituted with a heteroatom; and R⁶ and R⁷ may form a ring structure together with the nitrogen atom to which they are bonded.

In Formula (2-1), R⁶ and R⁷ are each independent of one another.

In Formula (2-1), R⁶ and R⁷ each represent a C₁-C₂₀ hydrocarbon group that may be substituted with a heteroatom, preferably a C₁-C₁₂ hydrocarbon group that may be substituted with a heteroatom, more preferably a C₁-C₈ hydrocarbon group that may be substituted with a heteroatom, further preferably a C₁-C₆ hydrocarbon group that may be substituted with a heteroatom, and even more preferably a C₁-C₄ hydrocarbon group that may be substituted with a heteroatom.

Examples of hydrocarbon groups that are not substituted with a heteroatom and that are represented by R⁶ and R⁷ include methyl groups, ethyl groups, propyl groups, isopropyl groups, n-butyl groups, s-butyl groups, t-butyl groups, pentyl groups, neopentyl groups, hexyl groups, octyl groups, benzyl groups, phenyl groups, and the like, with methyl groups, ethyl groups, neopentyl groups, and phenyl groups being preferred, with methyl groups, ethyl groups, isopropyl groups, and t-butyl groups being more preferred, and with ethyl groups, isopropyl groups, and t-butyl groups being even more preferred.

Examples of hydrocarbon groups that are substituted with a heteroatom and that are represented by R⁶ and R⁷ include a hydrocarbon group in which at least one —CH₂— constituting the hydrocarbon group is substituted with, for example, at least one of —O—, —NH—, —N(R)— (wherein R represents a hydrocarbon group), —S—, —SO₂—, or the like.

R⁶ and R⁷ may form a ring structure together with the nitrogen atom to which they are bonded.

Examples of amine compounds represented by Formula (2-1) include t-butyl-methylamine, t-butyl-ethylamine, t-butyl-propylamine, t-butyl-isopropylamine, t-butyl-butylamine, t-butyl-s-butylamine, di (t-butyl) amine, t-butyl-phenylamine, t-butyl-benzylamine, and the like.

### Amine Compound Represented by Formula (2-2)

### Formula (2-2):

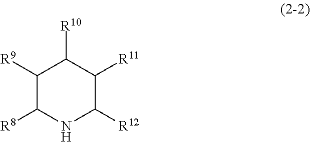

wherein R⁸, R⁹, R¹⁰, R¹¹, and R¹² are each independent of one another; R⁸, R⁹, R¹⁰, R¹¹, and R¹² each represent a hydrogen atom or a hydrocarbon group; and when R⁸, R⁹, R¹⁰, R¹¹, and R¹² each represent a hydrocarbon group, they each represent a C₁-C₂₀ hydrocarbon group that may be substituted with a heteroatom, and they may also form a ring structure together with the carbon atoms to which they are bonded.

In Formula (2-2), R⁸, R⁹, R¹⁰, R¹¹, and R¹² are each independent of one another.

R⁸, R⁹, R¹⁰, R¹¹, and R¹² each represent a hydrogen atom or a hydrocarbon group.

When R⁸, R⁹, R¹⁰, R¹¹, and R¹² each represent a hydrocarbon group, they each represent a C₁-C₂₀ hydrocarbon group that may be substituted with a heteroatom, preferably a C₁-C₁₂ hydrocarbon group that may be substituted with a heteroatom, more preferably a C₁-C₆ hydrocarbon group that may be substituted with a heteroatom, further preferably a C₁-C₄ hydrocarbon group that may be substituted with a heteroatom, and even more preferably a C₁-C₂ hydrocarbon group that may be substituted with a heteroatom.

Examples of hydrocarbon groups that are not substituted with a heteroatom and that are represented by R⁸, R⁹, R¹⁰, R¹¹, and R¹² include methyl groups, ethyl groups, propyl groups, isopropyl groups, n-butyl groups, s-butyl groups, t-butyl groups, pentyl groups, neopentyl groups, hexyl groups, octyl groups, benzyl groups, phenyl groups, and the like, with methyl groups, ethyl groups, neopentyl groups, and phenyl groups being preferred, and methyl groups and ethyl groups being more preferred.

Examples of hydrocarbon groups that are substituted with a heteroatom and that are represented by R⁸, R⁹, R¹⁰, R¹¹, and R¹² include a hydrocarbon group in which at least one —CH₂— constituting the hydrocarbon group is substituted with, for example, at least one of —O—, —NH—, —N(R)— (wherein R represents a hydrocarbon group), —S—, —SO₂—, or the like.

R⁸, R⁹, R¹⁰, R¹¹, and R¹² may form a ring structure together with the carbon atoms to which they are bonded.

R⁸, R⁹, R¹⁰, R¹¹, and R¹² are each particularly preferably a hydrogen atom, methyl group, or ethyl group.

Examples of amine compounds represented by Formula (2-2) include piperidine, 4-methyl-piperidine, 4-ethyl-piperidine, 4-isopropyl-piperidine, 4-(t-butyl)-piperidine, 2,6-dimethyl-piperidine, 2,6-diethyl-piperidine, 2,6-diisopropyl-piperidine, 2,6-di(t-butyl)-piperidine, 3,5-dimethyl-piperidine, 3,5-diethyl-piperidine, 3,5-diisopropyl-piperidine, 3,5-di(t-butyl)-piperidine, and the like.

### Amine Compound Represented by Formula (2-3)

### Formula (2-3):

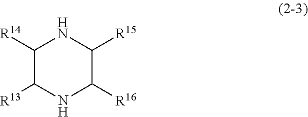

R¹³, R¹⁴, R¹⁵, and R¹⁶ are each independent of one another; R¹³, R¹⁴, R¹⁵, and R¹⁶ each represent a hydrogen atom or a hydrocarbon group; and when R¹³, R¹⁴, R¹⁵, and R¹⁶ each represent a hydrocarbon group, they each represent a C₁-C₂₀ hydrocarbon group that may be substituted with a heteroatom, and they may form a ring structure together with the carbon atoms to which they are bonded.

In Formula (2-3), R¹³, R¹⁴, R¹⁵, and R¹⁶ are each independent of one another.

R¹³, R¹⁴, R¹⁵, and R¹⁶ each represent a hydrogen atom or a hydrocarbon group.

When R¹³, R¹⁴, R¹⁵, and R¹⁶ each represent a hydrocarbon group, they each represent a C₁-C₂₀ hydrocarbon group that may be substituted with a heteroatom, preferably a C₁-C₁₂ hydrocarbon group that may be substituted with a heteroatom, more preferably a C₁-C₆ hydrocarbon group that may be substituted with a heteroatom, further preferably a C₁-C₄ hydrocarbon group that may be substituted with a heteroatom, and even more preferably a C₁-C₂ hydrocarbon group that may be substituted with a heteroatom.

Examples of hydrocarbon groups that are not substituted with a heteroatom and that are represented by R¹³, R¹⁴, R¹⁵, and R¹⁶ include methyl groups, ethyl groups, propyl groups, isopropyl groups, n-butyl groups, s-butyl groups, t-butyl groups, pentyl groups, neopentyl groups, hexyl groups, octyl groups, benzyl groups, phenyl groups, and the like, with methyl groups, ethyl groups, neopentyl groups, and phenyl groups being preferred, and methyl groups and ethyl groups being more preferred.

Examples of hydrocarbon groups that are substituted with a heteroatom and that are represented by R¹³, R¹⁴, R¹⁵, and R¹⁶ include a hydrocarbon group in which at least one —CH₂— constituting the hydrocarbon group is substituted with, for example, at least one of —O—, —NH—, —N(R)— (wherein R represents a hydrocarbon group), —S—, —SO₂—, or the like.

R¹³, R¹⁴, R¹⁵, and R¹⁶ may form a ring structure together with the carbon atoms to which they are bonded.

R¹³, R¹⁴, R¹⁵, and R¹⁶ each particularly preferably represent a hydrogen atom, a methyl group, or an ethyl group.

Examples of amine compounds represented by Formula (2-3) include piperazine, 2,6-dimethyl-piperazine, 2,6-diethyl-piperazine, 2,6-diisopropyl-piperazine, 2,6-di(t-butyl)piperazine, 2,6-diphenyl-piperazine, 2,6-dibenzyl-piperazine, 3,5-dimethyl-piperazine, 3,5-diethyl-piperazine, 3,5-diisopropyl-piperazine, 3,5-di(t-butyl)piperazine, 3,5-diphenyl-piperazine, 3,5-dibenzyl-piperazine, and the like.

### Amine Compound Represented by Formula (2-4)

### Formula (2-4):

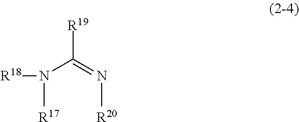

wherein R¹⁷, R¹⁸, R¹⁹, and R²⁰ are each independent of one another; R¹⁷, R¹⁸, R¹⁹, and R²⁰ each represent a hydrogen atom or a hydrocarbon group; and when R¹⁷, R¹⁸, R¹⁹, and R²⁰ each represent a hydrocarbon group, they each represent a C₁-C₂₀ hydrocarbon group that may be substituted with a heteroatom, and they may form a ring structure together with the carbon atom and/or at least one of the nitrogen atoms to which they are bonded.

In Formula (2-4), R¹⁷, R¹⁸, R¹⁹, and R²⁰ are each independent of one another.

R¹⁷, R¹⁸, R¹⁹, and R²⁰ each represent a hydrogen atom or a hydrocarbon group.

When R¹⁷, R¹⁸, R¹⁹, and R²⁰ each represent a hydrocarbon group, they may be a C₁-C₂₀ hydrocarbon group that may be substituted with a heteroatom, preferably a C₁-C₁₂ hydrocarbon group that may be substituted with a heteroatom, more preferably a C₁-C₆ hydrocarbon group that may be substituted with a heteroatom, further preferably a C₁-C₄ hydrocarbon group that may be substituted with a heteroatom, and particularly preferably a C₁-C₂ hydrocarbon group that may be substituted with a heteroatom.

Examples of hydrocarbon groups that are not substituted with a heteroatom and that are represented by R¹⁷, R¹⁸, R¹⁹, and R²⁰ include methyl groups, ethyl groups, propyl groups, n-butyl groups, s-butyl groups, t-butyl groups, pentyl groups, neopentyl groups, hexyl groups, octyl groups, benzyl groups, phenyl groups, and the like, with methyl groups, ethyl groups, neopentyl groups, and phenyl groups being preferred, and methyl groups and ethyl groups being more preferred.

Examples of hydrocarbon groups that are substituted with a heteroatom and that are represented by R¹⁷, R¹⁸, R¹⁹, and R²⁰ include a hydrocarbon group in which at least one —CH₂— constituting the hydrocarbon group is substituted with, for example, at least one of —O—, —NH—, —N(R)— (wherein R represents a hydrocarbon group), —S—, —SO₂—, or the like.

R¹⁷, R¹⁸, R¹⁹, and R²⁰ may form a ring structure together with the carbon atom and/or at least one of the nitrogen atoms to which they are bonded.

Examples of the ring structure formed by R¹⁷, R¹⁰, R¹⁹, and R²⁰ together with the carbon atom and/or at least one of the nitrogen atoms to which they are bonded include a 6- to 8-membered ring structure formed by R¹⁸, the nitrogen atom to which R¹⁸ is bonded, R¹⁹, and the carbon atom to which R¹⁹ is bonded; a 5- to 7-membered ring structure formed by R¹⁷, the nitrogen atom to which R¹⁷ is bonded, the carbon atom to which R¹⁹ is bonded, R²⁰, and the nitrogen atom to which R²⁰ is bonded; a fused ring structure of the above 6- to 8-membered ring structure formed by R¹⁸, the nitrogen atom to which R¹⁰ is bonded, R¹⁹, and the carbon atom to which R¹⁹ is bonded, and the above 5- to 7-membered ring structure formed by R¹⁷, the nitrogen atom to which R¹⁷ is bonded, the carbon atom to which R¹⁹ is bonded, R²⁰, and the nitrogen atom to which R²⁰ is bonded.

R¹⁷, R¹⁸, R¹⁹, and R²⁰ are each particularly preferably a hydrogen atom, a methyl group, or an ethyl group.

The ring structure formed by R¹⁷, R¹⁸, R¹⁹, and R²⁰ together with the carbon atom and/or at least one of the nitrogen atoms to which they are bonded is preferably a fused ring structure of a 7-membered ring formed by R¹⁸, the nitrogen atom to which R¹⁸ is bonded, R¹⁹, and the carbon atom to which R¹⁹ is bonded, and a 6-membered ring formed by R¹⁷, the nitrogen atom to which R¹⁷ is bonded, the carbon atom to which R¹⁹ is bonded, R²⁰, and the nitrogen atom to which R²⁰ is bonded.

Examples of the amine compound represented by Formula (2-4) include imidazole, 1-methylimidazole, 2-methylimidazole, 4-methylimidazole, diazabicycloundecene(1,8-diazabicyclo[5.4.0-7-undecene]), 1,5-diazabicyclo[4.3.0]-5-nonene, and the like.

In the blocked polyisocyanate composition of the present invention, the amount of an amine compound represented by Formulas (2-1) to (2-4) relative to the blocked polyisocyanate compound is determined according to the required physical properties, and is not particularly limited. The amount is usually within the range of 5 to 25 mol %, preferably within the range of 10 to 20 mol %, and more preferably within the range of 13 to 18 mol %, based on the amount of the effective isocyanate groups in the blocked polyisocyanate compound, taken as 100 mol. The effective isocyanate groups in the blocked polyisocyanate compound refer to isocyanate groups that are regenerated when the blocking agent is dissociated from the blocked polyisocyanate compound.

### Curable Resin Composition

The curable resin composition of the present invention comprises the blocked polyisocyanate composition of the present invention and a compound having an isocyanate-reactive group.

### Compound Having an Isocyanate-Reactive Group

Examples of the compound having an isocyanate-reactive group include compounds having two or more active hydrogen groups, such as polyols, polyamines, and alkanolamines. These compounds having an isocyanate-reactive group may be a mixture of two or more.

The compound having an isocyanate-reactive group is preferably a polyol or polyamine.

### Polyol

In the present invention, polyols are compounds having two or more hydroxyl groups. Examples include polyester polyols, polyether polyols, acrylic polyols, polyolefin polyols, fluorine polyols, and the like. Preferred polyols among these are acrylic polyols, in terms of weather resistance, chemical resistance, and hardness. However, in terms of mechanical strength and oil resistance, polyester polyols are preferred. These polyols may be a mixture of two or more.

### Polyester Polyol

Polyester polyols can be obtained, for example, by the condensation reaction of a single dibasic acid or a mixture of two or more dibasic acids with a single polyhydric alcohol or a mixture of two or more polyhydric alcohols.

Examples of dibasic acids used in polyester polyols include carboxylic acids, such as succinic acid, adipic acid, dimer acid, maleic anhydride, phthalic anhydride, isophthalic acid, terephthalic acid, and 1,4-cyclohexanedicarboxylic acid; and the like.

Examples of polyhydric alcohols used in polyester polyols include ethylene glycol, propylene glycol, diethylene glycol, 1,4-butanediol, neopentyl glycol, 1,6-hexanediol, trimethylpentanediol, cyclohexanediol, trimethylolpropane, glycerol, pentaerythritol, 2-methylolpropanediol, ethoxylated trimethylolpropane, and the like.

As a specific method for producing polyester polyols, for example, the condensation reaction can be carried out by mixing the dibasic acid with polyhydric alcohol mentioned above, and heating the mixture at about 160 to 220° C. Alternatively, for example, polycaprolactones obtained by the ring-opening polymerization of lactones, such as ε-caprolactone, with polyhydric alcohols can also be used as polyester polyols. These polyester polyols can be modified by using, for example, aromatic diisocyanates, aliphatic diisocyanates, alicyclic diisocyanates, and polyisocyanates obtained from them. Among these, in terms of weather resistance, yellowing resistance, etc., polyester polyols are preferably modified by using aliphatic diisocyanates, alicyclic diisocyanates, and polyisocyanates obtained from them.

When the curable resin composition of the present invention is used as an aqueous-based paint, some carboxylic acids derived from the dibasic acid etc. in the polyester polyol can be allowed to remain and neutralized with a base, such as amine or ammonia, thereby forming the polyester polyol into a water-soluble or water-dispersible resin.

### Polyether Polyol

Examples of polyether polyols include active hydrogen compounds, such as aliphatic amine polyols, aromatic amine polyols, Mannich polyols, polyhydric alcohols, polyhydric phenols, and bisphenols; compounds obtained by adding alkylene oxides to these active hydrogen compounds; and the like. These polyether polyols may be a mixture of two or more.

Examples of aliphatic amine polyols include alkylenediamine-based polyols and alkanolamine-based polyols. These polyol compounds are polyfunctional polyol compounds having terminal hydroxyl groups obtained by the ring-opening addition of at least one cyclic ether, such as ethylene oxide or propylene oxide, using alkylenediamine or alkanolamine as an initiator. As the alkylenediamine, known compounds can be used without limitation. Specifically, C₂₋₈ alkylenediamines, such as ethylenediamine, propylenediamine, butylenediamine, hexamethylenediamine, and neopentyldianine, are preferably used. These aliphatic amine polyols may be a mixture of two or more.

Aromatic amine polyols are polyfunctional polyether polyol compounds having terminal hydroxyl groups obtained by the ring-opening addition of at least one cyclic ether, such as ethylene oxide or propylene oxide, using an aromatic diamine as an initiator. As the initiator, a known aromatic diamine can be used without limitation. Specific examples include 2,4-toluenediamine, 2,6-toluenediamine, diethyltoluenediamine, 4,4′-diaminodiphenylmethane, p-phenylenedianine, o-phenylenediamine, naphthalenediamine, and the like. Among these, toluenediamine (2,4-toluenediamine, 2,6-toluenediamine, or a mixture thereof) is particularly preferably used. These aromatic amine polyols may be a mixture of two or more.

Mannich polyols are active hydrogen compounds obtained by the Mannich reaction of phenol and/or an alkyl-substituted derivative thereof, formaldehyde, and alkanolamine, or polyol compounds obtained by the ring-opening addition polymerization of the active hydrogen compounds with at least one of ethylene oxide and propylene oxide. These Mannich polyols may be a mixture of two or more.

Examples of polyhydric alcohols include dihydric alcohols (e.g., ethylene glycol, propylene glycol, 1,4-butanediol, 1,6-hexanediol, diethylene glycol, triethylene glycol, dipropylene glycol, and neopentyl glycol), trihydric or higher alcohols (e.g., glycerol, trimethylolpropane, pentaerythritol, methylglucoside, sorbitol, and sucrose), and the like. These polyhydric alcohols may be a mixture of two or more.

Examples of polyhydric phenols include pyrogallol, hydroquinone, and the like. These polyhydric phenols may be a mixture of two or more.

Examples of bisphenols include bisphenol A, bisphenol S, bisphenol F, low-condensates of phenols and formaldehyde, and the like. These bisphenols may be a mixture of two or more.

Polyether polyols can be obtained, for example, by any of the following Production Methods 1 to 3.

Production Method 1: A method of performing random or block addition of an alkylene oxide alone or a mixture of alkylene oxides to a polyhydroxy compound alone or a mixture of polyhydroxy compounds using a catalyst to obtain polyether polyols.

Examples of catalysts used in Production Method 1 include hydroxides (lithium, sodium, potassium, etc.), strong base catalysts (alcoholates, alkylamines, etc.), composite metal cyanide compound complexes (metal porphyrins, zinc hexacyanocobaltate complexes, etc.), and the like.

Examples of alkylene oxides used in Production Method 1 include ethylene oxide, propylene oxide, butylene oxide, cyclohexene oxide, styrene oxide, and the like.

Examples of polyhydroxy compounds used in Production Method 1 include the following (i) to (vi).
(i) diglycerin, ditrimethylolpropane, pentaerythritol, dipentaerythritol, etc.
(ii) sugar alcohol compounds, such as erythritol, D-threitol, L-arabinitol, ribitol, xylitol, sorbitol, mannitol, galactitol, and rhannitol
(iii) monosaccharides, such as arabinose, ribose, xylose, glucose, mannose, galactose, fructose, sorbose, rhamnose, fucose, and ribodesose
(iv) disaccharides, such as trehalose, sucrose, maltose, cellobiose, gentiobiose, lactose, and melibiose
(v) trisaccharides, such as raffinose, gentianose, and melezitose
(vi) tetrasaccharides, such as stachyose

### Production Method 2: a Method of Reacting Polyamine Compounds With Alkylene Oxides to Obtain Polyether Polyols.

Examples of polyamine compounds used in Production Method 2 include ethylene diamines and the like.

Examples of alkylene oxides used in Production Method 2 include those mentioned in Production Method 1.

Production Method 3: A Method of Polymerizing Acrylanide Etc. Using the Polyether Polyols Obtained in Production Method 1 or 2 As Media to Obtain so-Called Polymer Polyols.

### Acrylic Polyol

Acrylic polyols can be obtained, for example, by polymerizing polymerizable monomers having one or more active hydrogens per molecule, or by copolymerizing polymerizable monomers having one or more active hydrogens per molecule with other monomers copolymerizable with the polymerizable monomers, if necessary.

Examples of polymerizable monomers having one or more active hydrogens per molecule include the following (i) to (vi). These may be used singly or in a combination of two or more.
(i) acrylic acid esters having active hydrogen, such as 2-hydroxyethyl acrylate, 2-hydroxypropyl acrylate, and 2-hydroxybutyl acrylate
(ii) methacrylic acid esters having active hydrogen, such as 2-hydroxyethyl methacrylate, 2-hydroxypropyl methacrylate, 2-hydroxybutyl methacrylate, 3-hydroxypropyl methacrylate, and 4-hydroxybutyl methacrylate
(iii) (meth)acrylic acid esters having polyvalent active hydrogen, such as (meth)acrylic acid monoesters of triols, such as glycerol and trimethylolpropane
(iv) monoethers of polyether polyols (e.g., polyethylene glycol, polypropylene glycol, and polybutylene glycol) with the above (meth)acrylic acid esters having active hydrogen
(v) adducts of glycidyl (meth)acrylate with monobasic acids (e.g., acetic acid, propionic acid, and p-tert-butyl benzoic acid)
(vi) adducts obtained by the ring-opening polymerization of lactones (e.g., c-caprolactam and y-valerolactone) with the active hydrogen of the above (meta)acrylic acid esters having active hydrogen

Examples of monomers copolymerizable with the above polymerizable monomers include the following (i) to (iv). These may be used singly or in a combination of two or more.
(i) (meth)acrylic acid esters, such as methyl acrylate, ethyl acrylate, isopropyl acrylate, n-butyl acrylate, 2-ethylhexyl acrylate, methyl methacrylate, ethyl methacrylate, isopropyl methacrylate, n-butyl methacrylate, isobutyl methacrylate, n-hexyl methacrylate, cyclohexyl methacrylate, lauryl methacrylate, and glycidyl methacrylate
(ii) unsaturated carboxylic acids, such as acrylic acid, methacrylic acid, maleic acid, and itaconic acid; and unsaturated amides, such as acrylamide, N-methylolacrylamide, and diacetoneacrylamide
(iii) vinyl monomers having a hydrolyzable silyl group, such as vinyl trimethoxysilane, vinyl methyl dimethoxysilane, and γ-(meth)acrylopropyltrimethoxysilane
(iv) other polymerizable monomers, such as styrene, vinyl toluene, vinyl acetate, acrylonitrile, and dibutyl fumarate

As a specific method for producing acrylic polyols, for example, the above monomer components are subjected to solution polymerization in the presence of a known radical polymerization initiator, such as a peroxide or an azo compound, optionally followed by dilution with an organic solvent etc., thereby obtaining acrylic polyols.

When the curable resin composition of the present invention is used as an aqueous-based paint, aqueous-based acrylic polyols can be produced by solution polymerization of the above monomer components, and conversion to an aqueous layer, or by using a known method, such as emulsion polymerization. In that case, the acidic portions of carboxylic acid-containing monomers and sulfonic acid-containing monomers, such as acrylic acid and methacrylic acid, can be neutralized with amine or ammonia to make acrylic polyols water-soluble or water-dispersible.

### Polyolefin Polyol

Examples of polyolefin polyols include polybutadiene having two or more hydroxyl groups, hydrogenated polybutadiene having two or more hydroxyl groups, hydrogenated polyisoprene having two or more hydroxyl groups, and the like.

In the polyolefin polyol, the number of hydroxyl groups is preferably three because a higher coating film strength can be obtained.

### Fluorine Polyol

In the present invention, “fluorine polyols” refer to polyols containing fluorine in the molecule. Specific examples of fluorine polyols include the copolymers of fluoroolefin, cyclovinyl ether, hydroxyalkyl vinyl ether, and vinyl monocarboxylate disclosed in JPS57-34107A, JPS61-275311A, etc.

### Hydroxyl Value and Acid Value of Polyol

The lower limit of the hydroxyl value of the polyol is preferably 10 mgKOH/g or more, more preferably 20 mgKOH/g or more, and even more preferably 30 mgKOH/g or more.

On the other hand, the upper limit of the hydroxyl value of the polyol is not particularly limited, and may be, for example, 300 mgKOH/g or less.

Specifically, the hydroxyl value of the polyol is preferably 10 mgKOH/g or more and 300 mgKOH/g or less, more preferably 20 mgKOH/g or more and 300 mgKOH/g or less, and even more preferably 30 mgKOH/g or more and 300 mgKOH/g or less.

Further, the acid value of the polyol is preferably 0 mgKOH/g or more and 30 mgKOH/g or less.

The hydroxyl value and acid value can be measured according to JIS K1557.

The molar equivalent ratio of the isocyanate groups in the blocked polyisocyanate composition to the hydroxyl groups in the polyol (NCO/OH) is preferably 0.2 or more and 5.0 or less, more preferably 0.4 or more and 3.0 or less, and even more preferably 0.5 or more and 2.0 or less.

### Polyamine

Polyamines usable in the present invention may be those having two or more primary amino groups or secondary amino groups per molecule. Preferred among these are those having three or more such amino groups per molecule.

Specific examples of polyamines usable in the present invention include diamines, such as ethylenediamine, propylenediamine, butylenediamine, triethylenediamine, hexamethylenediamine, 4,4′-diaminodicyclohexylmethane, piperazine, 2-methylpiperazine, and isophoronediamine; chain polyamines having three or more amino groups, such as bishexamethylenetriamine, diethylenetriamine, triethylenetetramine, tetraethylenepentamine, pentamethylenehexamine, and tetrapropylenepentamine; and cyclic polyamines, such as 1,4,7,10,13,16-hexaazacyclooctadecane, 1,4,7,10-tetraazacyclodecane, 1,4,8,12-tetraazacyclopentadecane, and 1,4,8,11-tetraazacyclotetradecane.

### Alkanolamine

Alkanolamines usable in the present invention refer to compounds having an amino group and a hydroxyl group per molecule. Examples of alkanolamines include monoethanolamine, diethanolamine, aminoethylethanolamine, N-(2-hydroxypropyl)ethylenediamine, mono-, di-(n- or iso-)propanolamine, ethylene glycol-bis-propylamine, neopentanolamine, methylethanolamine, and the like.

### Mixing Ratio of Blocked Polyisocyanate Composition and Compound Having Isocyanate-Reactive Group

In the curable resin composition of the present invention, the mixing ratio of the blocked polyisocyanate composition and the compound having an isocyanate-reactive group is determined by the required physical properties, and is not particularly limited. The mixing ratio is generally within the following range: [the amount of effective isocyanate groups (mol) in the blocked polyisocyanate compound in the blocked polyisocyanate composition]/[the amount of active hydrogen groups (mol) in the compound having an isocyanate-reactive group]=0.2 to 5, and preferably 0.5 to 3. The effective isocyanate groups in the blocked polyisocyanate compound refer to isocyanate groups that are regenerated when the blocking agent is dissociated from the blocked polyisocyanate compound.

### Curing Catalyst

The curable resin composition of the present invention may further comprise a curing catalyst, in addition to the blocked polyisocyanate composition and a compound having an isocyanate-reactive group.

The curing catalyst is not particularly limited. Examples include tin compounds, such as dibutyltin dilaurate, dibutyltin di-2-ethylhexanate, dioctyltin dilaurate, dibutyltin diacetate, dibutyltin dioxide, dioctyltin dioxide, tin acetylacetonate, tin acetate, tin octylate, and tin laurate; bismuth compounds, such as bismuth octanoate, bismuth 2-ethylhexanoate, bismuth naphthenate, and bismuth acetylacetonate; titanium compounds, such as tetra-n-butyl titanate, tetraisopropyl titanate, and titanium terephthalate; tertiary amine compounds, such as triethylamine, N,N,N′,N′-tetramethylethylenediamine, N,N,N′,N′-tetramethylpropylenediamine, N,N,N′,N″,N″-pentamethyldiethylenetriamine, N,N,N′,N″,N″-pentamethyldipropylenetriamine, N,N,N′,N′-tetramethylguanidine, 1,3,5-tris(N,N-dimethylaminopropyl)hexahydro-S-triazine, 1,4-diazabicyclo[2.2.2]octane (DABCO), 1,8-diazabicyclo[5.4.0]undecene-7, triethylenediamine, N,N,N′,N′-tetramethylhexamethylenediamine, N-methyl-N′-(2-dimethylaminoethyl)piperazine, N,N′-dimethylpiperazine, dimethylcyclohexylamine, N-methylmorpholine, N-ethylmorpholine, bis(2-dimethylaminoethyl)ether, 1-methylimidazole, 1,2-dimethylimidazole, 1-isobutyl-2-methylimidazole, and 1-dimethylaminopropylimidazole; and quaternary ammonium salt compounds, such as tetraalkylammonium halides (e.g., tetramethylanmonium chloride), tetraalkylammonium hydroxides (e.g., tetramethylammonium hydroxide salts), tetraalkylanmonium organic acid salts (e.g., tetramethylanmonium-2-ethylhexanoate, 2-hydroxypropyl trimethylanmonium formate, and 2-hydroxypropyl trimethylammonium-2-ethylhexanoate).

The curing catalyst is preferably dibutyltin dilaurate or bismuth 2-ethylhexanoate.

The curable resin composition of the present invention may contain, if necessary, melamine-based curing agents, such as complete alkyl type-, methylol type-, and alkylamino group-type alkyl.

The content of the curing catalyst in the curable resin composition of the present invention is preferably 0.01 to 20 times by weight, and more preferably 0.1 to 10 times by weight, relative to the blocked polyisocyanate.

The blocked isocyanate composition and the curable resin composition of the present invention may comprise an organic solvent.

The organic solvent is preferably those that are compatible with the blocked polyisocyanate composition and the curable resin composition of the present invention.

Specific examples of organic solvents include hydrocarbons, such as benzene, toluene, xylene, cyclohexane, mineral spirit, and naphtha; ketones, such as acetone, methyl ethyl ketone, and methyl isobutyl ketone; esters, such as ethyl acetate, butyl acetate, and cellosolve acetate; alcohols, such as methanol, ethanol, 2-propanol, butanol, 2-methoxyethanol, 2-ethoxyethanol, and 2-butoxyethanol; polyhydric alcohols, such as ethylene glycol, propylene glycol, diethylene glycol, polyethylene glycol, and glycerol; water; and the like. These solvents may be used singly or in a combination of two or more.

Further, the curable resin composition of the present invention can be used as an aqueous thermosetting resin composition dissolved or dispersed in water. When the curable resin composition of the present invention is used as an aqueous thermosetting resin composition, surfactants, solvents that tend to be miscible with water, and the like may be used for the blocked polyisocyanate composition of the present invention, in order to improve the compatibility of the curable resin composition with water.

Examples of surfactants include anionic surfactants, such as aliphatic soaps, rosin acid soaps, alkyl sulfonates, dialkylaryl sulfonates, alkyl sulfosuccinates, polyoxyethylene alkyl sulfates, and polyoxyethylene alkylaryl sulfates; and nonionic surfactants, such as polyoxyethylene alkyl ethers, polyoxyethylene alkyl aryl ethers, and polyoxyethylene oxypropylene block copolymers.

Examples of solvents that tend to be miscible with water include diethylene glycol dimethyl ether, diethylene glycol diethyl ether, propylene glycol monomethyl ether acetate, propylene glycol monomethyl ether, propylene glycol dimethyl ether, dipropylene glycol dimethyl ether, isobutanol, butyl glycol, N-methylpyrrolidone, butyl diglycol, butyl diglycol acetate, and the like.

Preferred among the above solvents are diethylene glycol dimethyl ether, diethylene glycol diethyl ether, propylene glycol monomethyl ether, propylene glycol dimethyl ether, dipropylene glycol dimethyl ether, isobutanol, butyl glycol, N-methylpyrrolidone, and butyl diglycol; and more preferred are diethylene glycol dimethyl ether, diethylene glycol diethyl ether, propylene glycol dimethyl ether, and dipropylene glycol dimethyl ether. These solvents may be used singly or in a combination of two or more.

When the curable resin composition of the present invention is used as an aqueous thermosetting resin composition, ester solvents, such as ethyl acetate, n-butyl acetate, and cellosolve acetate, are not preferred because the solvents themselves may hydrolyze during storage.

In the blocked polyisocyanate composition and the curable resin composition of the present invention, known additives, pigments, and the like that are commonly used in this technical field can be used, if necessary. These may be used as a mixture with known blocked polyisocyanates.

Examples of additives include, but are not particularly limited to, various additives, such as UV absorbers, coloration inhibitors, antioxidants, leveling agents, antifoaming agents, rheology control agents, thixotropy-imparting agents, thickeners, light stabilizers, plasticizers, surfactants, coupling agents, flame retardants, rust inhibitors, fluorescent whitening agents, and pigment dispersants.

Examples of UV absorbers include hindered amine-based, benzotriazole-based, and benzophenone-based UV absorbers. Examples of coloration inhibitors include perchlorate-based and hydroxylamine-based coloration inhibitors. Examples of antioxidants include hindered phenol-based, phosphorus-based, sulfur-based, and hydrazide-based antioxidants.

Examples of pigments include, but are not particularly limited to, organic pigments, inorganic pigments, carbon-based pigments, metal foil pigments, rust-preventive pigments, and the like.

Examples of organic pigments include quinacridone-based, azo-based, phthalocyanine-based organic pigments, and the like. Examples of inorganic pigments include titanium oxide, barium sulfate, calcium carbonate, silica, and the like.

Examples of known blocked polyisocyanates include blocked polyisocyanates obtained by reacting polyisocyanates and known blocking agents. Examples of known blocking agents include phenol-based compounds, such as phenol, thiophenol, methylthiophenol, xylenol, cresol, resorcinol, nitrophenol, and chlorophenol; oxime-based compounds, such as acetone oxime, methyl ethyl ketone oxime, and cyclohexanone oxime; alcohol-based compounds, such as methanol, ethanol, n-propyl alcohol, isopropyl alcohol, n-butyl alcohol, isobutyl alcohol, t-butyl alcohol, t-pentanol, ethylene glycol monoethyl ether, ethylene glycol monobutyl ether, diethylene glycol monoethyl ether, propylene glycol monomethyl ether, and benzyl alcohol; pyrazole-based compounds, such as 3,5-dimethyl pyrazole and 1,2-pyrazole; triazole-based compounds, such as 1,2,4-triazole; halogen-substituted alcohol-based compounds, such as ethylene chlorohydrin and 1,3-dichloro-2-propanol; lactam-based compounds, such as c-caprolactam, 5-valerolactam, y-butyrolactam, and p-propyllactam; active methylene-based compounds, such as methyl acetoacetate, ethyl acetoacetate, acetylacetone, methyl malonate, and ethyl malonate; and the like. Other examples include imide-based compounds, mercaptan-based compounds, imine-based compounds, urea-based compounds, diaryl-based compounds, and the like.

### Storage Method

The blocked polyisocyanate composition and the curable resin composition of the present invention can be stored at 0° C. to 40° C.

### Curing Method

The method for curing the curable resin composition of the present invention is a method of heating the curable resin composition comprising the blocked polyisocyanate composition of the present invention and a compound having an isocyanate-reactive group, or a curable resin composition comprising the blocked polyisocyanate composition of the present invention and a compound having an isocyanate-reactive group, and further comprising a curing catalyst.

The heating temperature varies depending on the blocked polyisocyanate compound and an amine compound (Formulas (2-1) to (2-4)) in the blocked polyisocyanate composition used, but is generally about 60 to 250° C., and preferably about 80 to 200° C. The reaction time can be about 30 seconds to 5 hours, and preferably about 1 minute to 60 minutes.

The cured product of the present invention can be produced through the above method for curing the curable resin composition of the present invention.

### Application

The blocked polyisocyanate composition, curable resin composition, and cured product of the present invention can be used for paints, coating materials, inks, adhesives, pressure-sensitive adhesives, sealants, sealing materials, molding materials, and the like.

For example, the paints may be used for automobiles, buildings, metal products such as steel furniture, wooden products such as musical instruments, mechanical vehicles such as construction machinery, building materials such as sashes, and electrical appliances such as office equipment.

The coating materials may be used for artificial leather and rubber rolls. The sealants may be used for electronic components. The sealing materials may be used for automobiles and buildings. The molding materials may be used for 3D printers.

### EXAMPLES

The present invention is described in more detail below with reference to Production Examples and Examples; however, the present invention is not limited to these Examples.

### (1) Conditions of Infrared Spectroscopy

Device: FT-IR-6600, produced by JASCO Corporation
Measurement Method: total reflection measurement method (crystal: germanium)
Cumulative number: 16

### (2) Gas Chromatography

Device: Shimadzu GC-2030
Detector: FID
Column: DB-624/inner diameter: 0.32 mm, film thickness: 1.80 μm, length: 30.0 m
Oven temperature: maintained 50° C. for 10 min, then heated at a rate of 10° C./min to 250° C., followed by heating at 250° C. for 5 minutes
INJ: 150° C.
DET: 260° C.
Carrier gas: helium
Linear velocity: 48.5 cm/sec
Split ratio: 50.0
Injection volume: 1.0 μL

### Calculation of Effective NCO Group Content (%)

The effective NCO group content (%) as used here is determined by quantifying the amount of blocked isocyanate groups that can react with isocyanate-reactive groups and that are present in the blocked polyisocyanate compound. The effective NCO group content (%) is expressed as a mass (%) of the isocyanate groups and calculated according to the following formula: Effective NCO group content (%)={(solids content of the blocked polyisocyanate compound (mass (%)))×(mass of the polyisocyanate compound used in the reaction×NCO group content (%) of the polyisocyanate compound used in the reaction)}/(mass of the blocked polyisocyanate compound)/{solids content (%)}. When a solvent or the like was used for dilution, the values of those in the diluted state were used.

### Calculation of Solids Content

An absolute calibration curve for methyl isobutyl ketone (referred to below as “MIBK”) was created using gas chromatography to determine the content of MIBK in a sample, and the solids content (%) excluding MIBK from the total amount was calculated.

### Formulation of Curable Resin Composition

A blocked polyisocyanate compound, a compound having an isocyanate-reactive group, a curing catalyst, and an amine compound were added such that the effective NCO group (mol):hydroxyl group (mol):curing catalyst (mol):amine compound (mol) was 1.00:0.95:0 to 0.10:0.15. Then, MIBK was added such that the solids content (g) of the blocked polyisocyanate compound:solvent (g) was 1.0:1.0. The solvent referred to here includes the solvent used for diluting the blocked polyisocyanate compound. The effective NCO group (mol) and hydroxyl group (mol) were calculated according to the following formulas. Effective NCO groups (mol)=the amount of the blocked polyisocyanate compound used (g)×the effective NCO group content (%) of the blocked isocyanate/4202 Hydroxyl group (mol)=the amount of the polyol used (g)×the hydroxyl value of the polyol (mgKOH/g)/56.1

Production Example 1: Synthesis of MIBK Solution of Tert-Butylethylamine (Referred to Below as “tBEA”)-Blocked HDI Biuret (A-1)

500.0 g (NCO group: 2.59 mol) of HDI biuret (Desmodur N3200A, NCO group content: 22.8(%), produced by Sumika Covestro Urethane Company, Ltd.) and 350.0 g of MIBK were placed in a 2-liter three-necked reactor purged with nitrogen. Thereafter, 274.0 g (2.71 mol) of tBEA (produced by Tokyo Kasei Kogyo Co., Ltd.) was added dropwise at 25° C., the mixture was stirred at 25° C. for 2 hours, and the disappearance of the infrared absorption peak near 2270 cm⁻¹ corresponding to the isocyanate group was confirmed by infrared spectroscopy. The obtained reaction solution was concentrated under reduced pressure to remove tBEA and some MIBK, thus obtaining 1040.39 g of a tBEA-blocked MIBK solution of HDI biuret (A-1). The obtained tbEA-blocked HDI biuret (A-1) had a solids content of 72% and an effective NCO group content of 10%.

### Example 1

5.00 g of the tBEA-blocked HDI biuret (A-1) obtained in Production Example 1, 13.6 g of acrylic polyol (Acrit 6AN6000, produced by Taisei Fine Chemical Co., Ltd.), 0.387 g of dibutyltin dilaurate (produced by Tokyo Kasei Kogyo Co., Ltd.), and 0.180 g of tBEA (produced by Tokyo Kasei Kogyo Co., Ltd.) were added such that the formulation of a curable resin composition satisfied that the ratio of the effective NCO group (mol):hydroxyl group (mol):curing catalyst (mol):amine compound (mol) was 1.00:0.95:0.01:0.15. Further, 2.20 g of MIBK was added so that the amount of solvent was 1.0 time by weight relative to the blocked polyisocyanate compound. The mixture was then stirred for 30 minutes to prepare a curable resin composition.

The prepared curable resin composition was loaded to 80% of the volume of a 4 mL screw-cap tube and stored under a nitrogen atmosphere for one week. After one week, the curable resin composition was evaluated for storage stability and was found to lack stability in its cured state, while exhibiting stability in its liquid state. Table 1 shows the results. The evaluation results indicate those having storage stability as “Good” and those without storage stability as “Poor.”

### Examples 2 to 5 and Comparative Examples 1 to 4

Curable resin compositions were prepared in the same manner as in Example 1, except that the polyol compound, curing catalyst, and amine compound were replaced with those shown in Table 1. In Examples 4 and 5 and Comparative Examples 3 and 4, the evaluation for storage stability was performed in the same manner as in Example 1, except that the storage temperature and storage period were replaced with those shown in Table 1. Table 1 shows the results.

TABLE 1

| | | Example | | | | | Comparative Example | | | |
|---|---|---|---|---|---|---|---|---|---|---|
| | | 1 | 2 | 3 | 4 | 5 | 1 | 2 | 3 | 4 |
| Blocked polyisocyanate compound | A-1 | 5.00 | 5.00 | 5.00 | 5.00 | 10.00 | 5.00 | 5.00 | 5.00 | 10.00 |
| Compound having a reactive group | B-1 | 13.6 | 13.6 | 13.6 | 13.6 | | 13.6 | 13.6 | 13.6 | |
| | B-2 | | | | | 5.77 | | | | 5.77 |
| Curing catalyst | C-1 | 0.387 | 0.387 | | | 0.155 | 0.387 | | | 0.155 |
| | C-2 | | | 0.196 | | | | 0.196 | | |
| Amine compound | D-1 | 0.180 | | 0.180 | 0.180 | 0.360 | | | | |
| | D-2 | | 0.180 | | | | | | | |

| MIBK | | 2.20 | 2.20 | 2.20 | 2.20 | 4.40 | 2.20 | 2.20 | 2.20 | 4.40 |
|---|---|---|---|---|---|---|---|---|---|---|
| Hydroxyl group/effective NCO group (mol/mol) | | 0.95 | 0.95 | 0.95 | 0.95 | 0.95 | 0.95 | 0.95 | 0.95 | 0.95 |
| Curing catalyst/effective NCO group (mol/mol) | | 0.01 | 0.01 | 0.03 | | 0.01 | 0.01 | 0.03 | | 0.01 |
| Amine compound/effective NCO group (mol/mol) | | 0.15 | 0.15 | 0.15 | 0.15 | 0.15 | 0.00 | 0.00 | 0.00 | 0.00 |
| Storage stability | Room temperature, one week | Good | Good | Good | Good | Good | Poor | Poor | Good | Good |
| | 40° C., two weeks | | | | Good | Good | | | Poor | Good |
| | 40° C., one month | | | | | Good | | | | Poor |

A-1: tBEA-blocked HDI biuret obtained in Production Example 1
B-1: Acrylic polyol (Acrit 6AN6000, produced by Taisei Fine Chemical Co., Ltd.)
B-2: Polyester polyol (P510, produced by Kuraray Co., Ltd.)
C-1: Dibutyltin dilaurate
C-2: Bismuth 2-ethylhexanoate
D-1: tBEA
D-2: Diisopropylamine

The results of Examples 1 to 5 and Comparative Examples 1 to 4 revealed that the curable resin composition of the present invention comprising a blocked polyisocyanate compound and an amine compound exhibits superior storage stability for one week to one month under the same storage conditions, compared to curable resin compositions that do not comprise an amine compound.

1. A blocked polyisocyanate composition comprising:
a blocked polyisocyanate compound in which an isocyanate group of a polyisocyanate compound is blocked with a secondary amine compound represented by the following Formula (1); and
an amine compound represented by at least one formula selected from the groups consisting of the following Formulas (2-1), (2-2), (2-3), and (2-4):
Formula (1): 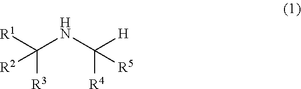
wherein R¹, R², R³, R⁴, and R⁵ are each independent of one another; R¹, R², and R³ each represent a C₁-C₂₀ hydrocarbon group that may be substituted with a heteroatom; R⁴ and R⁵ each represent a C₁-C₂₀ hydrocarbon group that may be substituted with a heteroatom, or a hydrogen atom; and R¹, R², R³, R⁴, and R⁵ may form a ring structure together with at least one of the carbon atoms to which they are bonded;
Formula (2-1): 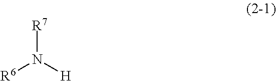
wherein R⁶ and R⁷ are each independent of one another; R⁶ and R⁷ each represent a C₁-C₂₀ hydrocarbon group that may be substituted with a heteroatom; R⁶ and R⁷ may form a ring structure together with the nitrogen atom to which they are bonded;
Formula (2-2): 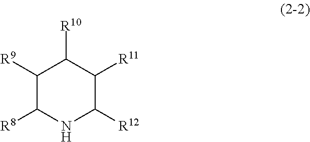
wherein R⁸, R⁹, R¹⁰, R¹¹, and R¹² are each independent of one another; R⁸, R⁹, R¹⁰, R¹¹, and R¹² each represent a hydrogen atom or a hydrocarbon group; and when R⁸, R⁹, R¹⁰, R¹¹, and R¹² each represent a hydrocarbon group, they each represent a C₁-C₂₀ hydrocarbon group that may be substituted with a heteroatom, and they may form a ring structure together with the carbon atoms to which they are bonded;
Formula (2-3): 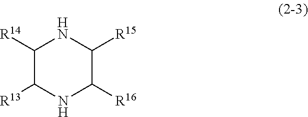
wherein R¹³, R¹⁴, R¹⁵, and R¹⁶ are each independent of one another; R¹³, R¹⁴, R¹⁵, and R¹⁶ each represent a hydrogen atom or a hydrocarbon group; and when R¹³, R¹⁴, R¹⁵, and R¹⁶ each represent a hydrocarbon group, they each represent a C₁-C₂₀ hydrocarbon group that may be substituted with a heteroatom, and they may form a ring structure together with the carbon atoms to which they are bonded; and
Formula (2-4): 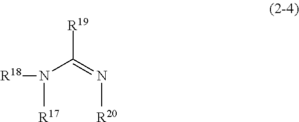
wherein R¹⁷, R¹⁸, R¹⁹, and R²⁰ are each independent of one another; R¹⁷, R¹⁸, R¹⁹, and R²⁰ each represent a hydrogen atom or a hydrocarbon group; and when R¹⁷, R¹⁸, R¹⁹, and R²⁰ each represent a hydrocarbon group, they each represent a C₁-C₂₀ hydrocarbon group that may be substituted with a heteroatom, and they may form a ring structure together with the carbon atom and/or at least one of the nitrogen atoms to which they are bonded.

2. The blocked polyisocyanate composition according to claim 1, wherein the polyisocyanate compound is
at least one polyisocyanate selected from the group consisting of aliphatic polyisocyanates, alicyclic polyisocyanates, aromatic polyisocyanates, and aromatic aliphatic polyisocyanates, or
a modified polyisocyanate formed from at least one member selected from the group consisting of aliphatic polyisocyanates, alicyclic polyisocyanates, aromatic polyisocyanates, and aromatic aliphatic polyisocyanates.

3. The blocked polyisocyanate composition according to claim 1, wherein R¹, R², and R³ in the secondary amine compound represented by Formula (1) each represent a C₁-C₂ hydrocarbon group, and R⁴ and R⁵ each represent a C₁-C₂ hydrocarbon group or a hydrogen atom.

4. A curable resin composition comprising the blocked polyisocyanate composition according to claim 1, and a compound having an isocyanate-reactive group.

5. The curable resin composition according to claim 4, wherein the compound having an isocyanate-reactive group is a polyol compound or a polyamine compound.

6. A curable resin composition comprising the curable resin composition according to claim 4 and a curing catalyst.

7. A cured product obtained by curing the curable resin composition according to claim 6.
